(19) United States
(12) Patent Application Publication
(10) Pub. No.: US 2015/0359386 A1
(43) Pub. Date: Dec. 17, 2015

(54) Easy Butter Maker

(71) Applicant: Damon Anthony Pfeifer, Canal Winchester, OH (US)

(72) Inventor: Damon Anthony Pfeifer, Canal Winchester, OH (US)

(21) Appl. No.: 14/304,228

(22) Filed: Jun. 13, 2014

(51) Int. Cl. A47J 43/04; A23C 15/02; A23D 7/005; A01J 15/10

(52) U.S. Cl. CPC A47J 43/04; A01J 15/10; A23C 15/02; A23D 7/005

(57) ABSTRACT

This Easy Butter Maker will be used for infused butter and oils.

This invention consists of an Easy Butter Maker for preparing infused butter and oils. It consists of 3 components, which are an upper pot, filter and lower pot. Although, on the side of the lower pot is a release valve. The lower pot you will place water and butter in. It will over fill the lower pot; it will activate the release valve. The herbs or spices will go into the filter. When you place the Easy Butter Maker on the stove it will heat the water and butter, by percolating upwards through the filter, which will be infused with the herbs and spices. At this point, it will generate to the upper pot and you will have the infused butter or oil.

### BACKGROUND OF THE INVENTION

1. Field of the Invention

This INVENTION will allow 3 different sizes, a 1 stick, 2 stick and a 4 stick Easy Butter Maker.

The present invention relates to an Easy Butter Maker for preparing various kinds of infused herbs or spices in the butter or oil. It will require electric or gas heat, water, herbs or spices, butter or oil.

Another purpose of the present invention is of providing an Easy Butter Maker, which essentially is a device that is easy to use, highly reliable.

This type of Easy Butter Maker can be used daily to infuse butter or oils. This product is generally used for household purposes.

This invention is concerned with such Easy Butter Maker constructions, and particularly to an improved readily manufactured construction that disperses the Easy Butter Maker to infuse herbs and spices in the butter. Through the filter, which has small holes that are construct in the bottom of the filter and above in the top filter. If the bottom unit is overfilled with water, butter or oil, it will cause the release valve to activate releasing a liquid spray.

### DESCRIPTIONS OF DRAWINGS

The Easy Butter Maker has 3 components to it. It has the upper unit, the filter and the bottom unit. On the side of the bottom unit it has a activator valve.

The bottom unit is where your water, butter or oil will go. The filter will have spices or herbs in its When you put the Easy Butter Maker on the stove the spices/herbs will infuse into butter and generate to the upper unit for pouring into a mold or container.

FIG. 1 is a front perspective view of the Easy Butter Maker, according to our new design;

FIG. 2 is a front view thereof;

FIG. 3 is a top view thereof;

FIG. 4 is a right side view thereof, being a mirror image

FIG. 5 is the left side view thereof, being a mirror image

FIG. 6 is the rear view thereof;

FIG. 7 is the top view of the filter

FIG. 8 is the bottom view of the filter

FIG. 9 is the side view of the filter

FIG. 10 is a rubber gasket

FIG. 11 is a top filter

FIG. 12 is the view of the lower part

### DESCRIPTION OF THE PRODUCT & HOW IT IS USED

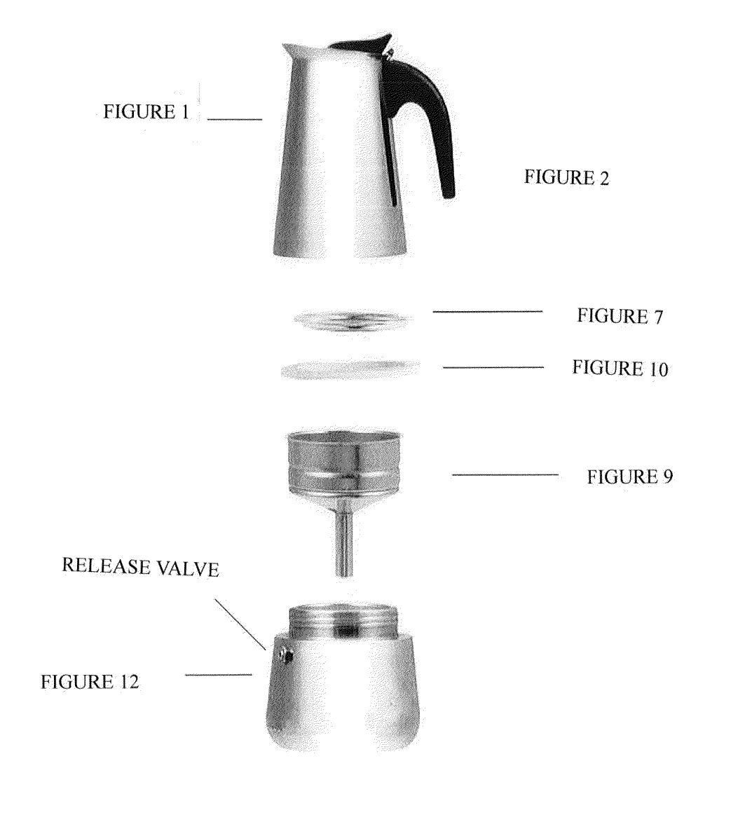

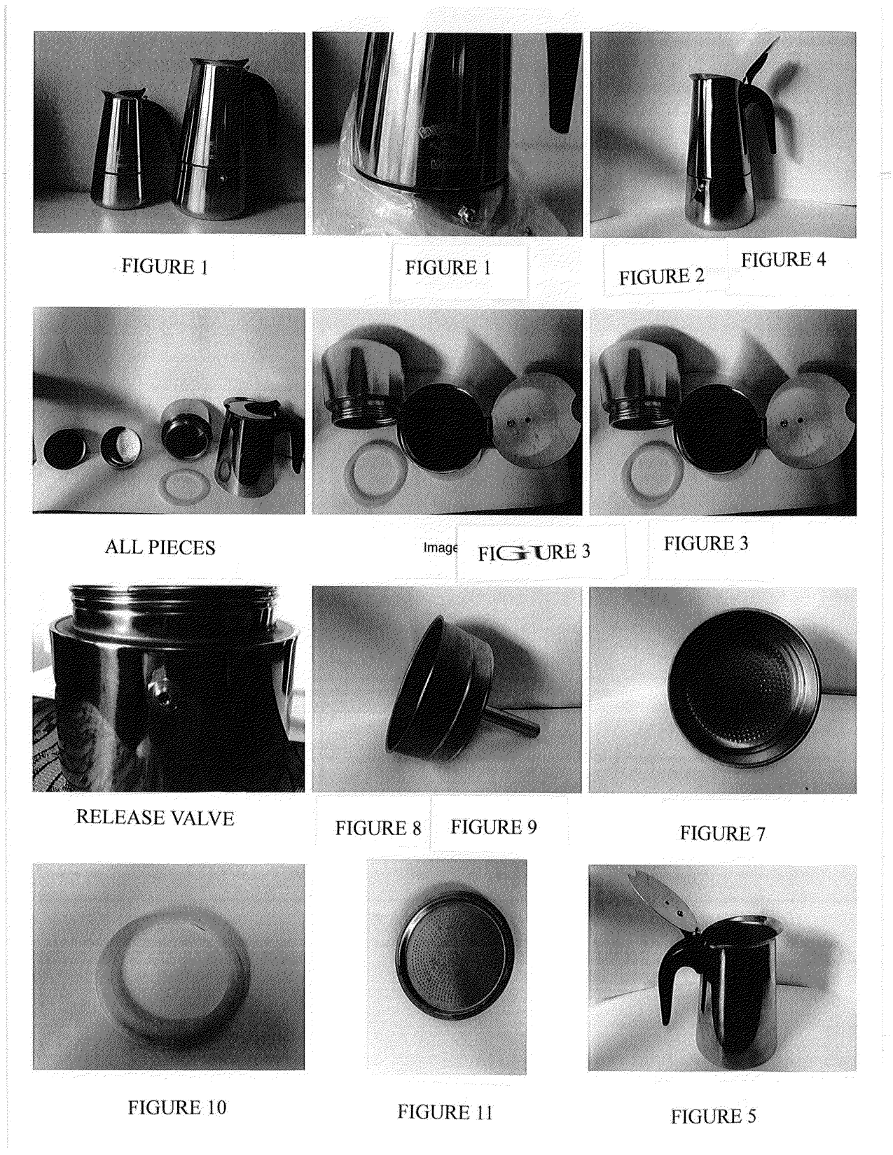

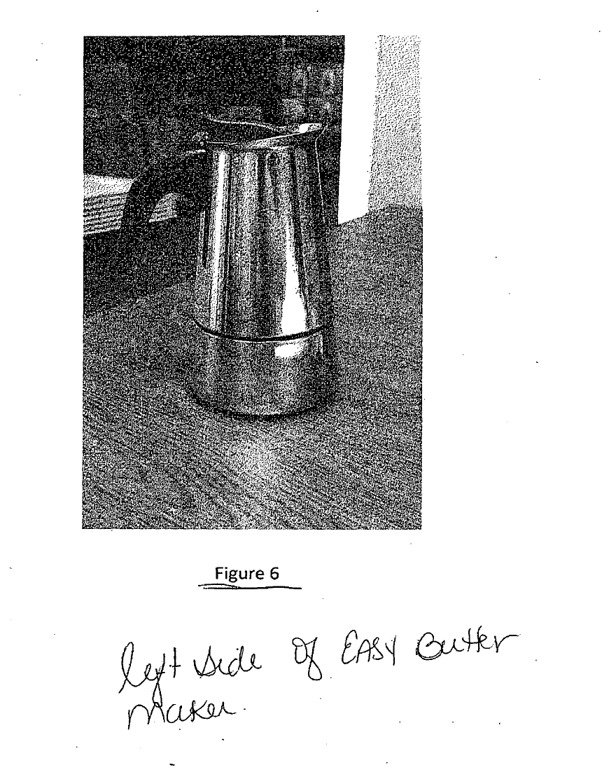

Referring to the drawing FIGS. 1 through 11 of this product and how it is works:

You will take FIG. 12 (lower pot) add water, butter or oil to it; do not fill above the release valve. At that point, you will take FIG. 7 (filter) and fill it with herbs or spices. Take FIG. 3 (upper pot) tighten with FIG. 12 to seal them. Then the product is ready to be placed on the stove to make your infused butter or oil.

What is claimed is:

1. An improved coffee maker/expresso maker, which may be used for other purposes then a coffee maker. This unit will comprise a locking assembly for the components being an upper pot, filter, release valve and lower pot. The lower pot may hold butter or oil and water, the filter will contain herbal mixture or spices, and the upper pot will maintain the infused butter or oil in it until the lower pot has released all butter or oil to the upper pot. This is a method of infusing butter/oil with herbs and spices.
